(19) United States
(12) Patent Application Publication
(10) Pub. No.: US 2023/0221218 A1
(43) Pub. Date: Jul. 13, 2023

(54) DEVICE FOR SAMPLING A HIGH FLOW RATE GAS LEAK

(71) Applicant: GRTGAZ, BOIS-COLOMBES (FR)

(72) Inventors: Corentin DUSSENNE, MONTESSON (FR); Jean-Luc FABRE, PARIS (FR)

(21) Appl. No.: 17/928,287

(22) PCT Filed: May 28, 2021
(86) PCT No.: PCT/FR2021/050973

§ 371 Date: Nov. 29, 2022

(30) Foreign Application Priority Data
May 29, 2020 (FR) FR2005687

(51) Int. Cl. G01N 1/22; G01M 3/16

(52) U.S. Cl. CPC G01N 1/2247; G01M 3/16

(57) ABSTRACT

A device for quantitatively detecting a leak of a gas of interest including a suction pipe having an upstream suction inlet intended to be brought into the vicinity of a region within which a leak is to be detected, a ventilation apparatus generating a gas stream in the suction pipe having a flow rate greater than 300 m3/H circulating from the upstream suction inlet to the downstream of the pipe, and downstream of the ventilation apparatus, a sampling member.

### TECHNICAL FIELD

The present disclosure relates to the detection of gas leaks, for example methane, on infrastructures in which gas circulates. The disclosure particularly relates to devices that allow detecting these leaks and quantifying them by sampling gas resulting from these leaks.

### BACKGROUND

The detection of gas leaks, for example methane, on gas transport and treatment infrastructures is particularly critical, both with regard to safety and with regard to the limitation of greenhouse gas emissions. These infrastructures can for example be methane terminals, delivery stations, compressor stations, storage sites, etc. Of course, methane is not the only gas for which it is wished to detect leaks and other infrastructures may involve the implementation of a gas leak detection.

Particularly, a quantitative detection of gas leaks is necessary, so as to obtain an image of these leaks over the entire infrastructure. The quantification of leaks then allows: determining which maintenance operations to carry out, facilitating the declaration to an administration of the amount of greenhouse gas emitted by an infrastructure, and finally better understanding the evolution of a leak over time.

A difficulty to overcome relating to safety is the compliance with the ATEX (ATmospheresEXplosives) standard, defined in particular in European directives 2014/34/EU and 1999/92/EC, which involve particular technical characteristics on the devices to be used in a context where explosive gases such as methane are contained.

In general, to measure an amount of gas escaping through a leak, suction means are used to collect the gas resulting from the leak diluted in the ambient medium (air). The measurement of the concentration by a detector, here made of methane, of this diluted stream, combined with the knowledge of the suction flow rate of the suction means, allows deducing the leak flow rate by the following relation:

Qₗₑₐₖ=Q_{suction}[CH₄]_{detector} [Math]

Qₗₑₐₖ the flow rate of the methane leak, Q_{suction} the suction flow rate, and [CH4]_{detector} the methane concentration measured by the detector.

As can be seen, the relation presented above gives a correct result insofar as the gas escaping through the leak point is completely suctioned, and where an ideal mixture is obtained between the dilution air and the gas of interest.

This type of measurement is currently performed by means of the technique referred to as “bagging”. In this technique, the leaking methane is suctioned by means of a pump (compatible with the ATEX standard, generally a membrane pump) then the methane concentration is detected downstream of the suction means by means of a methane detector and of the relation presented above.

The leaking methane is suctioned by means of this pump and of a flexible tube fixed in the vicinity of a previously identified leak. The tube and the region where the leak comes from are wrapped in a bag such as a canvas or a pouch, which allows limiting the influence of external parameters such as the wind, the leak direction, etc. The bag remains provided with a source of fresh air (an opening). To attach the bag, adhesives are generally used to position the tube opposite the fresh air source. The use of the bag allows suctioning the entire leak once the steady state is reached, insofar as the tube and the opening(s) are sufficiently well positioned.

The diameter of the tube is generally chosen to be thin enough to properly mix the leak and the air stream coming from outside, before the methane detector is used to measure the concentration of methane.

The bagging solution has many drawbacks. First of all, the pump used requires an electrical power supply, which can be difficult to implement in an ATEX context. To overcome this difficulty, it has been proposed to use generator sets, but these are not compatible with the ATEX standard and must therefore be installed remotely in areas called ATEX2 areas and then to use extension cords to reach the regions where the leaks are located (0 or 1 ATEX areas).

Another drawback of the bagging technique is the need for material. Particularly, it is necessary to use an ATEX canvas, scissors, adhesive, pinching and clamping devices for making the bag and placing it around the region where the leaks are located. Connectors such as hoses and valves are necessary to use the pump. Finally, apparatuses such as the pump, the methane detector, extension cords and an electrical power supply (possibly with fuel) are necessary.

As a result, the bagging solution is time-consuming, and requires the presence of two operators and a duration of up to one hour for the installation.

The apparatus which was marketed under the name “Hi-Flow Sampler” by the American company Bacharach is also known from the prior art. This apparatus has the drawback of only proposing too weak suction and of using a detector limited to a detection of the order of 300 ppm. This apparatus is therefore:
unsuitable for quantifying methane emissions of the order of 10 to 20 litres per hour, and
too sensitive to the wind and the geometry of the leaking equipment.

Furthermore, the pump used by this apparatus has a limited suction capacity, which prevents properly estimating the significant leaks.

The disclosure aims to solve at least some of the aforementioned drawbacks.

### SUMMARY

To this end, the disclosure proposes a device for sampling a leak of a gas of interest including:
a suction pipe having an upstream suction inlet intended to be brought into the vicinity of a region within which a leak is to be sampled,
a ventilation apparatus generating a gas stream circulating in the suction pipe from the upstream suction inlet to the downstream of the suction pipe,
downstream of the ventilation apparatus, a member for sampling the gas circulating in the suction pipe.

According to one general characteristic, the device includes a tank receiving gas sampled by the sampling member.

The use of a tank allows collecting a mixture including the gas leak to subsequently implement concentration measurements of the gas of interest. Particularly, it is possible to implement these measurements in a laboratory and to use apparatuses that cannot be used in the vicinity of the leak (for example a chromatograph).

This tank can be opened when the device is making the suction and closed when the suction is complete, for example by means of a valve.

The use of a tank is advantageous for a subsequent measurement because it allows using detectors that are very sensitive to pressure fluctuations, and smoothing the pressure variations over time.

Moreover, the use of a tank allows obtaining a smoothing of the instantaneous concentration of the gas of interest over the duration of the sampling, and thus improving the accuracy of the measurement.

In one particular embodiment, the ventilation apparatus can generate a gas stream having a flow rate greater than 300 m³/H.

It has been observed by the inventors that, by using a ventilation apparatus with a flow rate greater than 300 cubic meters per hour (m³/H), a bag cannot be used (bagging technique). In fact, if this flow rate is sufficiently greater than the flow rate of the leak (which is generally the case above 300 m³/H), the entire leak is suctioned as soon as the suction inlet upstream of the suction pipe is brought into the vicinity of the leak (typically at a distance of the order from 10 to 50 cm).

The absence of a bag allows limiting the amount of material to be used and simplifies and accelerates the operations of detection and quantification of the leaks.

Those skilled in the art will be able to choose which ventilation apparatus to use depending on the leaks to be detected in an application, and ventilation apparatus able to produce flow rates greater than 300 m³/H are known. As an indication, the ventilation apparatus can be a Venturi effect apparatus or a fan, as explained in more detail below.

The sampling member can be connected to a detector or to a tank. Two alternatives are therefore possible: the direct measurement of the concentration of the gas of interest by a detector of the device connected to the sampling member, or the storage in a tank connected to the sampling member to allow a subsequent measurement of this concentration. The disclosure therefore facilitates the quantitative detection of a leak.

According to one particular embodiment, the ventilation apparatus generates a gas stream with a flow rate greater than 1,000, 2,000, or 3,000 m³/H.

By using these flow rates, the influence of the wind around the leak is further avoided.

According to one particular embodiment, the device is configured so that the speed of the gas stream is included between 50 and 130 m/s or between 50 and 100 m/s.

Those skilled in the art will be able to choose a suitable flow rate (for example greater than 300, 1,000, 2,000 or 3,000 m³/H) and therefore a suitable ventilation apparatus for this flow rate, to have a speed included in one of these ranges, based in particular on the other parameters of the apparatus such as the diameter of the suction pipe.

According to one particular embodiment, the device includes a detector of a concentration of the gas of interest receiving gas sampled by the sampling member.

Detectors capable of detecting concentrations of the gas of interest of the order of hundreds of ppm or preferably of the order of a ppm, will be preferably chosen.

As an indication, this detector can be in the tank or between the sampling member and the tank.

According to one particular embodiment, the detector is a detector chosen from the list including:
Herriott cell infrared absorption detector,
semiconductor detector,
photolonization detector (usually referred to as PID),
flame ionization detector (usually referred to as FID),
Open Path Laser Spectrometer (OPLS) with a Quantum Cascade Laser (QLC) source,
electrochemical cell,
catalytic filament, and
katharometer.

Some of these detectors can detect gases such as methane at concentrations of the order of ppm. Therefore, by combining these very sensitive detectors with the ventilation apparatus presented above, it is possible to detect a particularly wide range of leaks, from the lightest to the largest in terms of flow rate.

Also, it is particularly interesting to use a detector with a sensitivity of the order of ppm because the suction flow rate here is high. In fact, the more the suction is powerful and the more the leak is diluted, the more the detector must be efficient.

It has been observed by the inventors that with a detector of this type and a suction at a flow rate greater than 300 m³/H, leaks from buried pipes can be detected.

According to one particular embodiment, the suction pipe is flared at its upstream suction inlet.

This particular embodiment makes it easier to position the suction pipe in the vicinity of the leak.

According to one particular embodiment, the device includes a gas mixer disposed in the suction pipe downstream of the upstream suction inlet and upstream of the sampling member.

This mixer allows improving the homogeneity of the mixture to ensure that the concentration, measured for example by the detector, clearly illustrates the actual concentration.

According to one particular embodiment, the ventilation apparatus is a Venturi effect apparatus including an injector of a motive gas arranged in the vicinity of the upstream suction inlet of the suction pipe.

The Venturi effect apparatuses are particularly well suited for use in an ATEX context because their operation is purely pneumatic. Indeed, the motive gas injector can be connected to a gas supply (for example compressed air in cylinders) by an apparatus which can be a tube provided with a valve to initiate the suction.

The injector of the motive gas is oriented towards the inside of the suction pipe so that a depression appears in the vicinity of the upstream suction inlet of the suction pipe, to cause this suction.

For example, the injector of the motive gas opens out into a constriction or restriction in the suction pipe located in the vicinity of the upstream suction inlet of the suction pipe.

Preferably, the motive gas is an inert gas that does not affect a subsequent measurement of the concentration of the gas of interest. For example, air can be used since the leak is already mixed with air.

The suction pipe can be dimensioned and a pressure can be chosen for the additional gas that allows generating a flow rate greater than 300 m³/H (for example 2 bars).

According to one particular embodiment, the ventilation apparatus includes a fan supplied with electrical energy by a battery.

The fan here is an electric machine capable of driving in rotation a paddle wheel configured, during its rotation, to cause a suction.

This fan can be of the axial type, with a shaft arranged in the upstream-downstream direction of the suction pipe.

Alternatively, this fan can be of the radial type, with a shaft arranged in a plane orthogonal to the upstream-downstream direction of the suction pipe.

The use of electric batteries makes it easier to transport the apparatus and allows not using a generator set (possibly with extension cords).

According to one particular embodiment, the device is a device according to the ATEX standard, for example a device according to the European directive 2014/34/EU, and/or a device according to the AMCA Standard 99-0401 (“AMCA: Air Movement and Control Association”, American professional association).

As an indication, a device according to the ATEX standard can be provided with an explosion proof enclosure, can be configured to prevent the production of sparks, can be provided with an encapsulation of electrical circuits, with an immersion of a portion of the device in an oil, with a powder filling, or even with an overpressurization of a portion of the device.

According to one particular embodiment, the suction pipe is rigid.

According to one particular embodiment, the device further includes, at its upstream suction inlet, a flange or a skirt (for example bell-shaped).

The skirt can be flexible and can limit the influence of external parameters (for example wind). Furthermore, the skirt or the flange enhances the suction in the region located outside the suction pipe in front of the upstream suction inlet.

According to one particular embodiment, the suction pipe has a length included between 20 and 200 centimeters, and a diameter included between 3 and 30 centimeters.

Thus, the suction pipe can be easily transported and handled by an operator.

It can be noted that the diameter of the suction pipe can vary within this range, for example if the suction pipe includes a flare extending from the upstream suction inlet.

As an indication, the diameter will be chosen with the desired flow rate value, to maintain a speed of the gas stream included between 50 and 130 m/s or between 50 and 100 m/s.

According to one particular embodiment, the device further includes a calculator of a leak flow rate based on a concentration delivered by the detector.

This particular embodiment can be implemented when the device is equipped with the detector.

This calculator takes into account the flow rate of the stream generated by the ventilation apparatus.

According to one particular embodiment, the sampling member is provided with several orifices.

According to one particular embodiment, the tank is a flexible bag.

This flexible bag can be advantageously emptied before use, to facilitate its transport, and filled insofar as it deforms/inflates.

As an indication, it is possible to use a flexible bag which has a capacity of the order of 1.5 L (which can be filled with the gas coming from the sampling member in about ten seconds for a flow rate in the pipe of 2,500 m³/H. These 1.5 L can correspond to a pressure inside the bag of a few millibars above the atmospheric pressure.

Also, the flexible bag can be a deformable plastic bag without degradation and without resistance for gas filling applications.

A flexible bag will provide a good representation of the leak.

The disclosure also proposes a method for using a device as defined above, in which a leak is sampled from the surface of the ground (typically a leak coming from a pipe buried in the ground), the device further including a cover surrounding its upstream suction inlet (with a sealed connection between the cover and the suction inlet), the method including:
the device is placed with its suction inlet in the vicinity of the surface of the ground (typically with the vertical pipe, perpendicular to the ground), so that the cover defines a suction region of the ground (around the inlet), and
a spacer structure is placed between, on the one hand, the suction region of the ground and, on the other hand, the device and its cover, to leave free air passages between the edges of the cover and the upstream suction inlet, and between the suction region of the ground and the upstream suction inlet.

These air passages allow having a mixture between the leak and the outside air. The cover nevertheless allows limiting the dispersion of the leak.

For example, the spacer structure can be a grid.

### BRIEF DESCRIPTION OF THE DRAWINGS

Other characteristics and advantages of the present disclosure will become apparent from the description given below, with reference to the appended drawings which illustrate one exemplary embodiment without any limitation. In the figures:

FIG. 1 is a schematic representation of a device according to one example.

FIG. 2 is a schematic representation of a device similar to that of FIG. 1 with an additional gas cylinder and another form of injector.

FIG. 3 is a schematic representation of a device according to another example.

FIG. 4 is a schematic representation of a device according to another example.

FIG. 5A is a representation of an example of a sample tube.

FIG. 5B represents the sample tube of FIG. 5A in a suction pipe.

FIG. 6A is a representation of another example of a sample tube.

FIG. 6B represents the sample tube of FIG. 6A in a suction pipe.

### DETAILED DESCRIPTION

Devices which allow sampling gas leaks will now be described. This sampling allows quantitatively detecting gas leaks. Two alternatives will be described: the quantitative detection by means of a detector of the device, or the subsequent detection from gas stored in a tank (these alternatives are nevertheless compatible with each other).

In the following examples, methane is the gas of interest to be detected. The disclosure is nevertheless in no way limited to the detection of methane and is also aimed at the detection of other gases.

By “quantitatively detecting”, it is meant both determining that this gas is present, and determining the intensity of the leak, for example by estimating a concentration of this gas or also by estimating a flow rate associated with the leak.

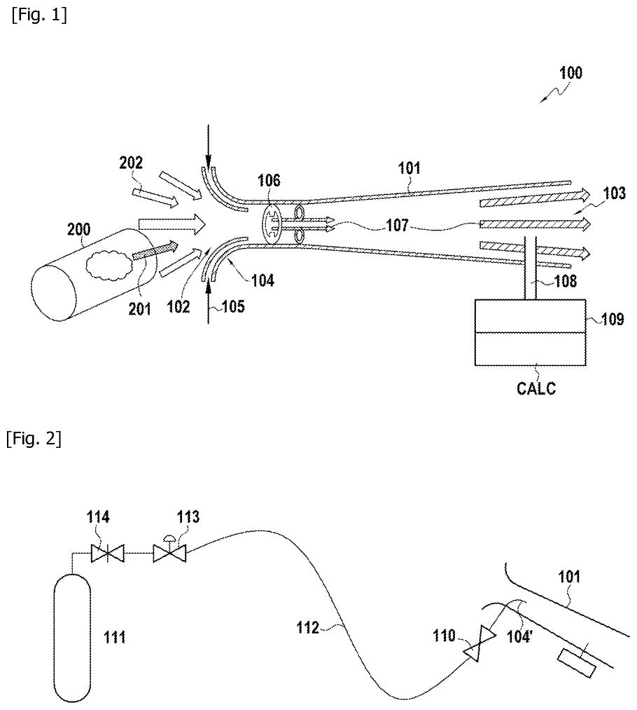

FIG. 1 represents a quantitative leak detection device 100 (that is to say a sampling device which can also perform quantitative detection).

This device includes a suction pipe 101, here a rigid pipe made for example of a plastic material made of aluminum or cardboard. The suction pipe 101 has a length included between 10 and 200 centimeters, and a diameter included between 3 and 30 centimeters. Thus, the suction pipe 101 can be easily handled by an operator.

The suction pipe 101 includes an upstream suction inlet 102 and a downstream end 103. The upstream suction inlet 102 is intended to be brought into the vicinity of a region within which it is desired to detect a leak. For example, an operator can handle the suction pipe to bring it into an area where there is a suspicion of a leak.

In the example illustrated, the leak comes from a pipe 200 and it is represented by an arrow 201 which illustrates the stream of methane which escapes from the pipe 200. The upstream suction inlet is therefore brought to a short distance from the leak, for example a distance less than 50 centimeters or even less than 10 centimeters.

The suction pipe 101 is flared at the upstream suction inlet 102 to facilitate the placement of the suction pipe in the vicinity of the leak.

The device 100 is equipped with a ventilation apparatus of the Venturi effect type, which includes an annular injector 104 formed by a pipe portion concentric with the suction pipe 101 extending into the suction pipe from the upstream suction inlet 102 to the end of the flared portion of the suction pipe. Thus, the annular injector 104 injects a gas called motive gas into a constriction of the suction pipe located between the flared portion and the rest of the suction pipe, and oriented downstream of the suction pipe.

The disclosure is nevertheless in no way limited to the annular injectors, any injector opening out into a constriction of the suction pipe, placed in the vicinity of the upstream suction inlet and oriented downstream of the suction pipe, can be used.

A stream of motive gas 105 is injected by means of the annular injector 104. The elements placed upstream in the supply chain supplying this motive gas will be described in more detail with reference to FIG. 2.

This injection of motive gas sets a large air mass in motion, which generates a depression in front of the upstream suction inlet of the pipi. In this way, a suction is obtained.

The geometry of the suction pipe, its dimensions and the flow rate of the motive gas injection are configured to cause this suction, with a flow rate greater than 300 m³. As an indication, the apparatus marketed by the French company LACAYELLE SAS under the trade name VENTU 2450 can be used.

In addition to the methane stream 201, fresh air is also suctioned into a stream represented by the arrows 202.

Although this is optional, a mixer 106 is used here downstream of the suction inlet 102 to mix the methane stream 201 with the fresh air stream 202. The mixer 106 can be a static mixer.

A mixed stream 107 which circulates downstream of the suction pipe is thus obtained.

The methane can then be detected in this mixed air stream, for example by means of a sampling member, here a tube 108 which extends into the suction pipe downstream of the mixer and which is fluidly connected to a detector 109.

Here, the detector 109 is a Herriott cell infrared absorption detector or a semiconductor detector, and it delivers a concentration of methane contained in the mixed stream 107 with an accuracy of the order of 5 PPM.

As explained above, the disclosure finds application in the detection of leaks other than methane. In the following table, examples of the type of sensors matched with the detected molecules and their sensitivity threshold can be read:

TABLE 1

| Coupling to the | | | Sensitivity threshold | |
|---|---|---|---|---|
| suctioning member | Detector type | Detected molecule | (order of magnitude) | |
| Suitable for high | PID | COV | 1 | ppm |
| dilutions | FID | organic compound | 1 | ppm |
| | Herriot-type IR cells | Methane | 1 | ppm |
| | Semiconductor (2) | Any type | 10 | ppm |
| | OPLS to QCL source (1) | Methane | 5 to 10 | ppb |
| Less suitable but | Electrochemical cell | Tout type | 300 | ppm |

| | | |
|---|---|---|
| possible if little | Catalytic Filament | Fuels |
| diluted | semiconductor (2) | Tout type |
| | IR Detection | Methane, CO2 |
| | Katharometer | All types, but particularly |
| | | molecules with high thermal |
| | | conductivity (He, H2, etc.) |

The detectors that are suitable for using a tank, such as the RES tank described below, are well suitable for little diluted mixtures.

Although this is optional, the device 100 is also equipped with a CALC calculator of a leak flow rate from the concentration delivered by the detector 109.

The mixed stream 107 is obtained by mixing the methane stream 201, the fresh air stream 202 and the motive gas stream 105. That being said, it has been observed by the inventors of the present disclosure that the contribution of the motive gas stream is negligible and that the following relation applies to determine the flow rate of the methane leak:

Qₗₑₐₖ=Q_{suction}[CH₄]_{detector} [Math]

With Qₗₑₐₖ the flow rate of the methane leak, Q_{suction} the suction flow rate, and [CH4]_{detector} the methane concentration measured by the detector.

Possibly, a calibration step can allow verifying this relation.

The suction flow rate can be either known because it is provided by the manufacturer of the suction apparatus, or calculated from the dimensions of the suction pipe and the flow rate associated with the additional gas stream, or measured by a flow rate sensor.

Alternatively, the value of the suction flow rate can be deduced from a calibration curve obtained by observing different known leak flow rates.

Optionally, the computer CALC is equipped with a display allowing the calculated value of the leak flow rate to be displayed.

FIG. 2 represents a device similar to that of FIG. 1 with the elements necessary for the operation of the Venturi effect ventilation apparatus. The device of FIG. 2 differs from that of FIG. 1 in that it is provided with an injector 104′ which opens out in the center of the suction pipe.

In this figure, it can be seen that the injector 104′ is connected to a first low-pressure valve 110 which allows monitoring the operation of the suction apparatus. Upstream of this low-pressure valve, a cylinder 111 containing pressurized motive gas (for example air, carbon dioxide, or dinitrogen) has been connected. This cylinder is connected to the low-pressure valve by means of a tube 112, a regulator 113 adapted for the lower pressure at which it is desired to release the additional gas and a high-pressure valve 114.

It is noted that these elements are pneumatic and therefore easily compatible with the ATEX standard. Furthermore, the elements 110 to 114 may or may not be included in the device 100.

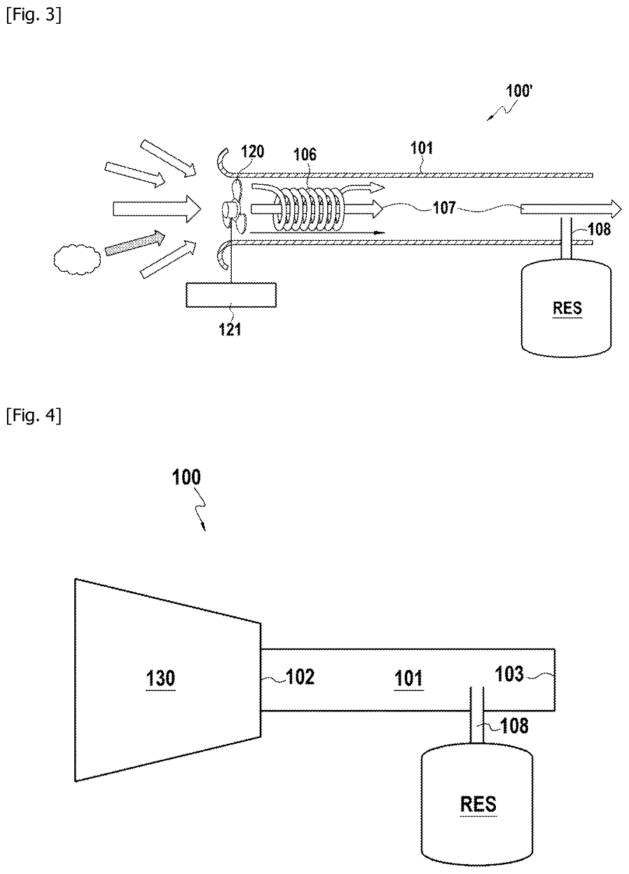

FIG. 3 represents a device 100′ which differs from that of FIGS. 1 and 2 in that it does not include a Venturi effect ventilation apparatus.

The elements represented in FIG. 3 and which bear the same references as those of FIGS. 1 and 2 are identical.

The ventilation apparatus of the device 100′ includes an axial fan 120. It can be noted that it is also possible to use a radial fan.

The axial fan is here an electric machine capable of driving in rotation a paddle wheel configured to cause, during its rotation, a suction with a flow rate greater than 300 m³/H.

This axial fan is supplied with electrical energy by a battery 121 of the device 100′. The battery 121 and the turbine 100 are preferably compatible with the ATEX standard.

Furthermore, the device of FIG. 3 is not equipped with a detector but with a tank RES receiving gas from the sample tube 108. This tank can be initially empty and be filled when the apparatus is used. The device 100′ is therefore a sampling device which allows implementing a quantitative detection.

The tank RES can be provided with a valve to be transported and allow the analysis of the gas it contains subsequently, for example in a laboratory. This embodiment allows implementing analyzes by chromatograph, for example.

Obtaining a flow rate for the leak will also depend on how long the tank has received gas.

FIG. 4 shows the device 100 of FIG. 1 in a configuration where it is further equipped with a skirt 130 having a diameter greater than that of the suction pipe, connected to the upstream suction inlet of the pipe, and flexible. This skirt allows surrounding a region in which a leak is located to limit the influence of external parameters such as the wind.

A flange can also be used instead of the skirt. The flange and the skirt further have the advantage of reinforcing the suction in front of the upstream suction inlet.

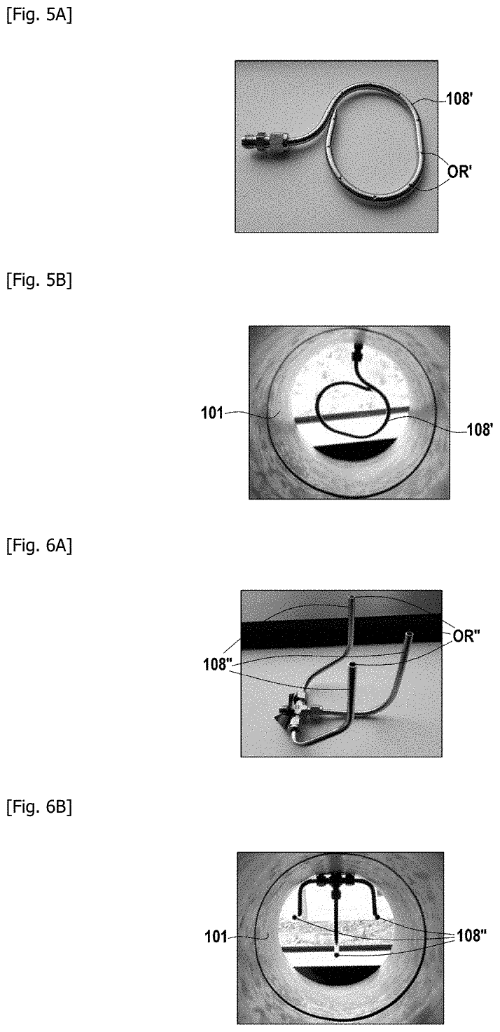

FIG. 5A represents a sample tube 108′ that can be mounted inside the suction pipe 101, as represented in FIG. 5B.

The sample tube 108′ can recover part of the mixed stream 107 described above to supply a detector such as the detector 109.

Here, the sample tube has the shape of a ring equipped, on its face facing the upstream suction inlet of the suction pipe 101, with a plurality of orifices OR′ evenly distributed and in which the mixed stream can penetrate.

The use of a plurality of orifices allows compensating for any lack of homogeneity of the mixed stream 107.

FIG. 6A represents another example of a sample tube, here a trident-shaped sample tube with tips configured to be arranged in the general direction of the suction pipe 101 (FIG. 6B), with orifices OR″ at the ends of the tips that face the upstream suction inlet of the suction pipe 101.

This configuration also allows compensating for a lack of homogeneity of the mixed stream 107.

The devices described above allow speeding up 10 to 50 times the leak detection and gas leak quantification operations.

Also, apparatuses using the Venturi effect have been made and have presented suction flow rates of the order of 2,450 m³/H, with good linearity observed with respect to the suction flow rate, and a characteristic measurement time of 20 seconds. In fact, the measurements are well repeatable with a coefficient of variation of less than 10% over a wide range of flow rates.

Furthermore, Venturi effect devices have been made with a mass of the order of 17 kilograms, including cylinders of compressed air. The devices according to the disclosure can therefore be completely handled.

1. A device for sampling a leak of a gas of interest comprising:
a suction pipe having an upstream suction inlet intended to be brought into the vicinity of a region within which a leak is to be sampled,
a ventilation apparatus generating a gas stream circulating in the suction pipe from the upstream suction inlet to the downstream of the suction pipe, and
downstream of the ventilation apparatus, a member for sampling the gas circulating in the suction pipe,
wherein the device includes a tank receiving gas sampled by the sampling member.

2. The device according to claim 1, wherein the ventilation apparatus generates a gas stream having a flow rate greater than 300 m³/H, or greater than 1,000, 2,000, or 3,000 m³/H.

3. The device according to claim 2, configured so that the speed of the gas stream is comprised between 50 and 130 m/s or between 50 and 100 m/s.

4. The device according to claim 1, wherein the device includes a detector of a concentration of the gas of interest receiving gas sampled by the sampling member.

5. The device according to claim 4, wherein the detector is a detector chosen from the list comprising:
a Herriott cell infrared absorption detector,
semiconductor detector,
photoionization detector,
flame ionization detector,
Open Path Laser Spectrometer with a Quantum Cascade Laser source,
electrochemical cell,
catalytic filament, and
katharometer.

6. The device according to claim 1, wherein the suction pipe is flared at the upstream suction inlet.

7. The device according to claim 1, comprising a gas mixer disposed in the suction pipe downstream of the upstream suction inlet and upstream of the sampling member.

8. The device according to claim 1, wherein the ventilation apparatus is a Venturi effect apparatus including an injector of a motive gas arranged in the vicinity of the upstream suction inlet of the suction pipe.

9. The device according to claim 1, wherein the ventilation apparatus includes a fan supplied with electrical energy by a battery.

10. The device according to claim 1, being a device according to one or more of the ATEX Standard and a device according to the AMCA Standard 99-0401.

11. The device according to claim 1, wherein the pipe is rigid.

12. The device according to claim 1, comprising, at the upstream suction inlet, a flange or a skirt.

13. The device according to claim 1, wherein the suction pipe has a length comprised between 20 and 200 centimeters, and a diameter comprised between 3 and 30 centimeters.

14. The device according to claim 4, comprising a calculator of a leak flow rate based on a concentration delivered by the detector.

15. The device according to claim 1, wherein the sampling member is provided with a plurality of orifices (OR′, OR″).

16. The device according to claim 1, wherein the tank is a flexible bag.

17. A method for using a device according to claim 1, wherein a leak is sampled from the surface of the ground and the device comprises a cover surrounding the upstream suction inlet, the method comprising:
placing the device with the suction inlet in the vicinity of the surface of the ground, so that the cover defines a suction region of the ground, and
placing a spacer structure between, on the one hand, the suction region of the ground and, on the other hand, the device and the cover, to leave free air passages between the edges of the cover and the upstream suction inlet, and between the suction region of the ground and the upstream suction inlet.
